(19) United States
(12) Patent Application Publication
(10) Pub. No.: US 2005/0067743 A1
(43) Pub. Date: Mar. 31, 2005

(54) Internal bubble cooling unit and method for extruded thin wall thermoplastic sheet

(76) Inventor: Eric Hatfield, Cincinnati, OH (US)

Correspondence Address: John M. Brandt, 60 Thaxter St., Hingham, MA, 02043, US

(21) Appl. No.: 10/672,560

(22) Filed: Sep. 29, 2003

(51) Int. Cl. B29C 47/88

(52) U.S. Cl. 264/563; 425/72.1; 264/237

(57) ABSTRACT

An internal bubble cooling process and apparatus for cooling extruded thermoplastic thin wall tubular bubbles emanating from an extrusion die head employing a first central channel for introducing cooling air into the bubble and a second channel formed between the outer wall of the central channel and the inner wall of the die head for withdrawing heated air from the bubble. Integration of the die head and airflow channels with a cooling tower and the method of use are also disclosed.

### BACKGROUND OF THE INVENTION

1. Field of the Invention

The invention resides in the field of apparatus and methods for the extrusion of thin wall thermoplastic sheet and more particularly relates to cooling the sheet as it emerges from the extrusion die.

2. Description of the Prior Art

The extrusion of thin wall thermoplastic sheet for use, for example, as wrapping and bagging products is well known in the prior art. The technique employed is to utilize an annular extrusion die fed by an extruder of molten thermoplastic material to produce a tubular bubble which is then cooled and drawn off for use in manufacturing finished goods.

In the process, a step known as internal bubble cooling is accomplished by placing a cooling tower forward of the die which acts as a heat exchanger by providing a means for introducing cooling air into the tubular bubble and withdrawing heated air from the same. A sheet of the desired material at ambient temperature is thus produced downstream of the die which may then be taken off by, for example, spooling into a roll.

The apparatus used in this process, particularly the die head and cooling tower, is available from Hosokawa Alpine American, Natick, Mass. among others. The mechanical parameters of the structure requires that the air exchange be carried out by the use of pipes channels or the like which pass through the interior of the die and into the tubular bubble at the point at which the extrusion emerges from the die. A cooling tower is most often used to distribute the airflow about the bubble in a controlled manner.

In all of the prior art devices used in the industry and known to the applicant, cooling air is introduced by a first channel formed on the interior of and next to the inner wall of the die and heated air is withdrawn through a second channel inside the first channel. That is, the heated air is withdrawn by a pipe or channel isolated from the inner surface of the die by the first channel supplying the cooling air to the bubble.

Applicant's invention is to reverse the use of these coaxial passages. As described below, the innermost channel is now arranged to transport the cooling air and the channel closest to the die, the heated air. This method requires not only a reconnection or redirection of the hot and cold air streams but also a reconfiguration of the cooling tower when one is employed.

### SUMMARY OF THE INVENTION

The invention may be summarized as an apparatus and method for cooling thin wall thermoplastic sheet produced in the form of an extruded tubular bubble from an annular die head. In contrast to the prior art, cooling air is delivered to the interior of the bubble by a central pipe, channel, or similar conduit and heated air is withdrawn from the bubble by an additional separate conduit positioned between the central pipe and the die head. In standard practice, a cooling tower is positioned within the bubble forward of the die head and the pipes or channels are similarly positioned within the cooling tower.

There are several advantages achieved by the invention in contrast to the prior art. In the prior art devices where the cooling air conduit is adjacent to the inner die wall, there is some transfer of heat from the die to the cooling air stream raising the cooling air stream temperature reducing the effective cooling capability thus slowing the output of the entire production process.

Additionally, when the cooling air stream is adjacent to the die, the die itself is cooled which can cause, among other things, melt fracture or a roughening of the film surface. Finally, it is sometimes necessary to notch or put a flat spot in the outer pipe to allow provide a passage for wires for internal heaters. This can upset the cooling airflow making it non-uniform around the circumference of the die. This may result in uneven film thickness presenting difficulties with further use of the product.

The above described features and advantages of the invention will be better understood from the description of the preferred embodiment taken with the drawings which follows.

### DESCRIPTION OF THE DRAWING

FIG. 1 is a perspective, cut away, partially schematic view of the preferred embodiment of the invention.

### DESCRIPTION OF THE PREFERRED EMBODIMENT

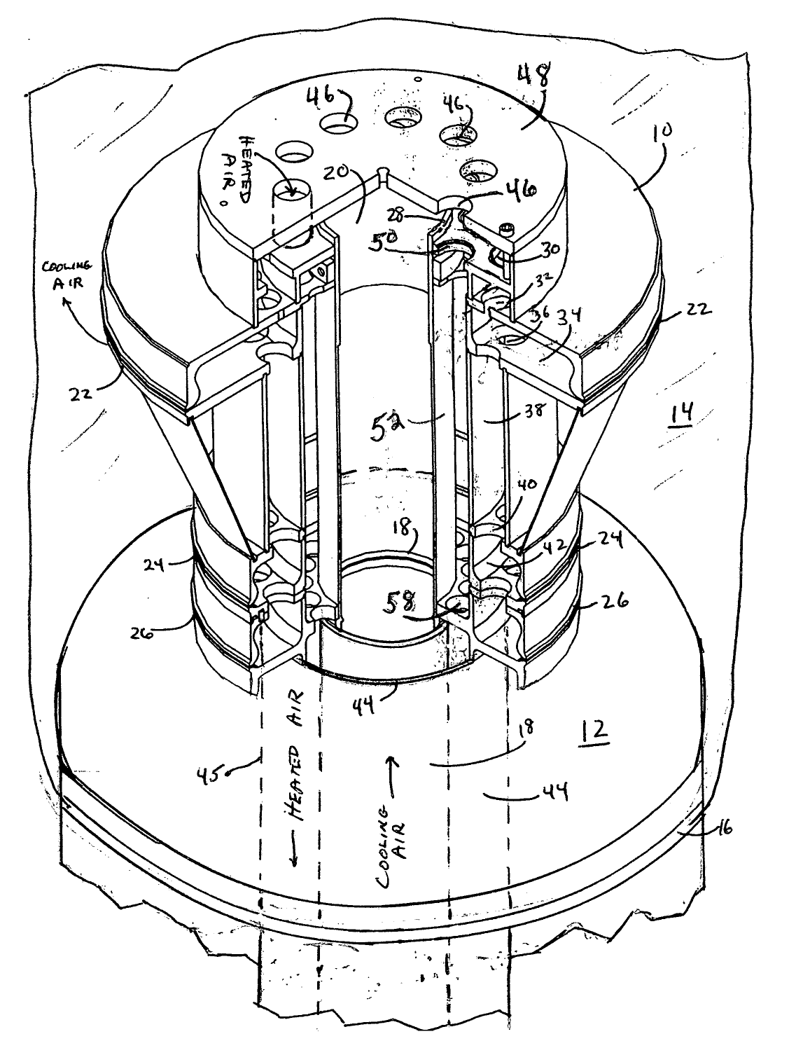

Referring first to FIG. 1, there is illustrated a perspective view of the preferred embodiment of the invention. Cooling tower 10 is shown mounted forward or atop of die head 12 which is supplied with an appropriate heated thermoplastic material by an extruder, not shown. In the process, die head 12 produces a continuous thin walled thermoplastic tubular bubble 14. Bubble 14, which completely surrounds tower 10, emerges in a heated state from slit port 16 extending completely around die head 12.

The material is then cooled to ambient temperature to allow take off and further processing. A standard procedure is to provide a flow of cooling air to the interior of the bubble while simultaneously removing air heated by the cooling process. This has been accomplished in the past by the use of conduits such as pipes, ducts, channels, and the like extending through the die head and cooling tower. The prior art practice is to employ a coaxial arrangement in which the outermost channel contiguous to the inner wall of the die head is used to transport the cooling air and the inner channel is used to withdraw the heated air.

In the present invention, the opposite is true, that is, pipe 18 extending through die head 12 and cooling tower 10 carries cooling air to chamber 20 of tower 10 which is routed through a series of internal ports to the exterior of the tower emerging into bubble 14 at circumferential exit slit ports 22, 24, and 26.

As shown, the internal cooling air distribution ports in tower 10 are positioned uniformly and repetitively about the tower in a horizontal plane. An example of a typical flow path is from chamber 20 to port 28 to port 30 to port 32 to chamber 34 to exit port 22. A portion of the cooling air will further travel through port 36 to chamber 38 to port 40 to chamber 42 to exit port 24. The arrangement of the ports and airflow process will similarly be repeated about the radius of the tower.

As cooling air flows into the bubble, air heated by heat exchange must be withdrawn, and, in the invention, this takes place through pipe 44 which passes through die head 12 adjacent the inner wall 45 of the die head and surrounds cooling air pipe 18. Pipe 44 communicates with the interior of bubble 14 through ports 46 in cap 48 of tower 10. As before, a plurality of ports and chambers form the path for the heated air withdrawal, beginning with port 46 to port 50 to chamber 52 to chamber 58 to pipe 44.

To summarize the process, the above described apparatus provides the means to insert cooling air into an extruded thermoplastic bubble through a central conduit positioned on the interior of the extrusion die, and to withdraw heated air through an additional separate conduit positioned between the central conduit and the interior wall of the die. While the process may be carried out without the use of an additional cooling tower, one is most often employed and may be constructed in a variety of ways to achieve the purposes of the invention

1. A cooling tower for introducing cooling air into and extracting heated air from an extruded thermoplastic thin wall tubular bubble, said tower adapted to be mounted forward of an extrusion die for producing said bubble, said tower comprising in combination:
a tower structure having an outer wall, an upstream end, a downstream end, and a longitudinal axis, said tower further having a first internal central channel extending from said downstream end for receiving said cooling air, said outer wall having at least one output port communicating with said central channel and said bubble for distributing cooling air within said bubble; said tower further having a second central channel surrounding and isolated from said first channel, said second channel extending from said upstream end for receiving said hot air, said outer wall having at least one input port communicating with said second channel and said bubble for withdrawing heated air from said bubble.

2. The tower of claim one wherein said tower has a plurality of output ports and said output ports are distributed about the periphery of said wall in spaced apart relationship along said longitudinal axis.

3. The tower of claim two wherein said output ports constitute annular slits.

4. The tower of claim one wherein said tower has a plurality of input ports, said tower further includes a cap affixed to said downstream end of said tower, and said input ports are disposed in said cap.

5. Internal bubble cooling apparatus for extruded thermoplastic thin wall tubular bubbles comprising in combination:
A. an annular die head having an inner axially disposed chamber, said die head connectable to an extruder for continuously extruding a tubular bubble of thin wall thermoplastic material;
B. a first pipe coaxially disposed within said die head chamber having an input end for receiving a supply of cooling air and an output end for communicating with the interior of said bubble; and
C. a second pipe coaxially disposed within said die head chamber surrounding said first pipe, said second pipe having an input end for communicating with the interior of said bubble and an output end for withdrawing heated air from said bubble.

6. The internal bubble cooling apparatus of claim 5 further including a cooling tower attached to said die head adapted to reside within said bubble, said tower connected to said first and second pipes, said tower having at least one output port for transferring cooling air to said bubble and at least one input port for withdrawing heated air from said bubble.

7. The method of cooling an extruded thermoplastic thin wall tubular bubble comprising the steps of:
A. providing an annular die head for receiving extruded thermoplastic material at one end and producing said bubble at the opposite end;
B. providing a first inner channel within said die adjacent the inner wall of said die;
C. providing a second inner channel within said first channel separated from said die inner wall by said first channel, both of said channels arranged to communicate with the interior of said bubble;
D. providing a source of cooling air under pressure to said second channel; and
E. withdrawing air heated within said bubble by heat exchange with said bubble through said first channel whereby said bubble is cooled by cooling air introduced into said bubble through said second channel and heated air is evacuated from said bubble through said first channel.

8. The method of claim 7 further including the step of providing a cooling tower forward of said die and within said bubble to uniformly distribute said cooling air within said bubble and to uniformly withdraw said heated air from said bubble.
